(19) United States
(12) Patent Application Publication
(10) Pub. No.: US 2006/0179030 A1
(43) Pub. Date: Aug. 10, 2006

(54) Method and system for processing information in monitoring system used in ethics, risk and/or value management and corresponding computer program product and corresponding storage medium

(75) Inventor: Kenan Tur, Potsdam (DE)

Correspondence Address: NORRIS, MCLAUGHLIN & MARCUS, P.A., 875 THIRD AVE, 18TH FLOOR, NEW YORK, NY, 10022, US

(73) Assignees: Hans-Joachim DOELEMEYER, Friedrichsdorf (DE); Kenan TUR, Potsdam (DE)

(21) Appl. No.: 10/496,363

(22) PCT Filed: Nov. 26, 2002
(86) PCT No.: PCT/EP02/13479

§ 371 Date: Sep. 27, 2004

(30) Foreign Application Priority Data
Nov. 26, 2001 (DE) 101 59 028.8

(51) Int. Cl. G06F 17/30

(52) U.S. Cl. 707/1

(57) ABSTRACT

The invention relates to a method and a system for processing information in monitoring systems of ethics, risk and/or value management and to a corresponding computer product and a corresponding storage medium, which can be especially used as a processing and management system for information that is supplied in the form of anonymous messages. The monitoring that allows to recognize already at an early level economical developments and process deviations that put a business at risk is therefore a specific field of use of the invention. The supplier of information logs onto the business keeper monitoring system where he finds a form which asks for all relevant information. The supply of information is strictly anonymous. The system evaluates the information and forwards it to a data base where it is checked for its reasonableness. Thematically unrelated complaints are extracted. The system processes the information and forwards it to the people concerned. If the supplier of information wishes to receive a feedback, he can establish an electronic anonymous mailbox to which only he has access.

The invention relates to a method and a system for processing information in monitoring systems of ethics, risk and/or value management and to a corresponding computer product and a corresponding storage medium, which can be used, in particular, as processing and management system for information that is based on anonymously sent messages. Monitoring for early identification of harmful developments and process deviations in the economy is therefore a specific area of application of the invention.

The changing values in society as well as globalization and the associated increase of international employment structures with different value systems set new rules for maintaining a common understanding in the individual economic systems. The resulting conflicts therefore manifest themselves not in the least in an increase of damaging white-collar crimes. The commitment of resources to minimize business risks in for-profit and nonprofit organizations has assumed the special place in the liquidity planning of each organization.

Economists and consulting firms have publicly announced that conventional control systems that are mainly based on the evaluation and extraction of the business data are not capable of adequately assessing the risk factors in today's new corporate process flows and complex structures. This is demonstrated by the yearly increase in the number of white-collar crimes. For example, damages in the order of approximately 45 billion DM were reported for the year 2000.

Studies have shown that each year more than 100 companies and/organizations with about 50,000 jobs filed for bankruptcy and are forced to cease operations due to irregularities that were not recognized early enough. These companies and/organizations have a negative balance sheet caused by economic forensic activities. However, this is only a subset of the companies that are experienced damage from white-collar crimes. In these companies, the monetary damage could not be recovered, so that the actual numbers are significantly higher.

For example, during the last five years 61% of the companies in Germany have fallen victim to white-collar crimes. Not less affected are government organizations. In 1997, damages due to falsified documents in government organizations were estimated by the BKA (the German Federal Bureau of Investigations) to be about 5 billion German marks.

The damages to the general economy were estimated to be 25-35 billion DM (1998), 30-40 billion DM (1999), and 40-45 billion DM (2000) (German Federal Bureau of Investigations).

In addition to the ethics and social management systems, which main task is to improve the integrity and loyalty of the employees, additional measures for compensating for the aforedescribed risks are needed, due to the increased liability (KonTraG) for all levels of management of the companies stipulated by the legislative. At the same time, companies and/organizations are discouraged from introducing ethics and social management systems because a suitable effective and measurable control instrument for minimizing the risk factors has not yet been discovered. Corporate representatives and economists also realized and recognized that the controlling systems used so far to minimize and control risk factors, are only able to partially cover certain business risks. The available means and instruments were unable to compensate risk factors in corporations and/organizations. This is also evident from the yearly official statistics of the federal government which indicates a continuous increase of harmful white-collar criminal activities.

An attempt was made to introduce such monitoring system by offering anonymous telephone hotlines. A significant disadvantage, which became obvious rather quickly, is firstly a lack for feedback because the caller remains anonymous, and secondly a very low trust of the potential user, because the calls have to be recorded which would enable voice analysis. Without feedback, this method can only occasionally—in particular automatically—process the messages, which is also quite expensive. The method itself is therefore unsatisfactory, because neither the anonymity of the caller nor eventually required callbacks can be guaranteed when using an anonymous telephone hotline.

All other attempts to entice employees, suppliers or other observers of irregularities to come forward with their observations, as was attempted for example by instituting audits, were unsuccessful due to the lack of anonymity.

The aforedescribed groups are more and more responsible in the corporate world and government organizations for identifying and evaluating tip-off and factual situations. A system for identifying, researching and documenting, etc. is not known thus far. An additional problem is that all responsible personnel can only make a limited contact time available for receiving tip-offs. The informant can only provide information or contact one of the aforementioned personnel at certain fixed times (business times).

Since there is presently no application available for uniquely documenting the processing such information, only those facts are available to the companies or an organization, as understood by the ombudsman or auditor or corruption investigator when relayed by the informant. This can result in misinterpretations and loss of information and time. It would therefore be desirable to be able to use a system that stores all dialogues and information, which can later be precisely analyzed by several parties.

Another approach to uncover irregularities involves the evaluation of financial data, which can be automated. However, the results of the evaluation are difficult to interpret. The greatest disadvantage of this method, however, is that a large amount of information from other related departments, processes or external partners as well as from the corporate environment cannot be taken into consideration at all, because the method is limited to the actual numbers.

Presently, only the results of white-collar crimes, rather than attempts or preparations of such activities can be envisioned and detected. The methods employed thus far do not enable the management to intervene in the running deviating process so as to prevent imminent damages from such activities.

These disadvantages, which are known from conventional methods, can be viewed as the reason why most companies, but also government organizations, have thus far been unable to compensate risk factors by using conventional measures and have therefore not further addressed this problem, although they are progressively more affected and the number of harmful white-collar crimes is increasing.

It is therefore an object of the invention to obviate the disadvantages of the conventional solutions and to enable, in particular, anonymous communication between an informant and the evaluating system. The invention is also intended to minimize the threshold level for uncovering risk factors, to document and later reconstruct the processing of the information, and to simultaneously increase the quality and relevance of the information for the organizations affected by the irregularities and process deviations. In addition, a method should be provided to check all types of processes and process flows for any type of deviation and to enable an immediate reaction, so as to reliably minimize the risk factors.

The object is solved by the invention by the characterizing features of claims 1, 26, 28, 29 and 30, in conjunction with the features in the preamble. Advantageous embodiments of the invention are recited in the dependent claims.

The invention has the particular advantage that with the method for processing information and monitoring systems for ethics, risk and/or value management, data received by a computer system are checked for predefined patterns and evaluated and/or classified, and that the data are erased or provided for further processing depending on the evaluation of the data, wherein further processing of the data includes the following steps:
evaluating the data,
depending on the results of the data evaluation, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

An arrangement for processing information in monitoring systems for ethics, risk and/or value management advantageously includes a processor which is configured so that information can be processed in the monitoring systems for ethics, risk and/or value management, such that data received by a computer system are searched and evaluated and/or classified with respect to predefined patterns, and that the data are erased or provided for further processing depending on the evaluation of the data, wherein further processing of the data includes the following steps:
evaluating the data,
depending on the results of the evaluation of the data, determining associated additional data by a database query,
depending on the results of the preceding steps, generating a data set that is enlarged by the associated data,
depending on the results of the preceding steps, transmitting at least a portion of the enlarged data set to a person or persons identified by the content of the enlarged data set.

A computer program product includes a computer readable storage medium with a program stored thereon, which enables a computer, after the program is loaded into memory of the computer, to process information in monitoring systems for the ethics, risk and/or value management, whereby data received by a computer system are searched and evaluated and/or classified according to predefined patterns, and whereby the data are erased or provided for further processing depending on the evaluation of the data, wherein further processing of the data includes the following steps:
evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

Information in monitoring systems for the ethics, risk and/or value management can be processed by using a computer-readable storage medium having stored thereon a program that enables a computer, after the program is loaded into memory of the computer, to process such information in monitoring systems for the ethics, risk and/or value management, whereby data received by a computer system are searched and evaluated and/or classified according to predefined patterns, and whereby the data are erased or provided for further processing depending on the evaluation of the data, wherein further processing of the data includes the following steps:
evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

In a method for using a process for information processing in monitoring systems for ethics, risk and/or value management, a supplier advantageously provides a monitoring systems for the ethics, risk and/or value management, wherein the monitoring system searches and evaluates and/or classifies data received by a computer system for predefined patterns, and erases the data or provides the data for further processing depending on the evaluation of the data, wherein

further processing of the data includes the following steps:

evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

With the present invention, the inhibition threshold for uncovering risk factors is minimized, in particular, by providing an anonymous communication channel, so that, on one hand, a larger number or information can be expected and, on the other hand, the quality and relevance of the anonymous information is enhanced by allowing callbacks to the informant. Automating the process supports thereby both aspects by:
increasing the confidence of the informant in maintaining anonymity
improving the quality and relevance of the information by enabling queries of large databases as well as a computerized evaluation of these data, for example, by using knowledge-based systems, and
enabling for the first time an unalterable documentation of the information and information processing to reexamine information and information processing related to deviating and embarrassing processes.

Advantageously, with the method of the invention currently running processes can be technically captured, allowing for the first time an immediate reaction to harmful activities.

The invention—in the following referred to as Business Keeper Monitoring System (BKMS)—represents a new approach. It provides on the highest level of anonymity and with the currently most innovative information technology an instrument that can be applied to uncover, reduce and prevent all risk factors. A particular advantage of this approach is that the inhibition threshold for uncovering risk factors can be minimized and simultaneously the quality and the relevance of the information for corporations, managers and/organizations can be increased.

BKMS ensures the continuous and permanent anonymity of all informants. At no time are personal data requested in conjunction with processing of the information data. All information data are processed by maintaining the strictest confidentiality.

Each information is entered via the anonymous application area of the specially secured Internet application of the BKMS. Data are transmitted via a SSL 128-bit line. This refers to an encryption method that is also used, for example, for banking transactions.

It will be understood that the system takes into consideration the current developments in the fields of security and encryption technology. In particular, all security and safety aspects are taken into account, like those used in security areas, such as banks, stock exchange, research facilities, Secret Service, etc.

The BKMS is used without any technical requirements from the requester, because an interface to the existing EDP system is not required. The method conforms in all aspects to the highest current security standards and is continuously updated.

Advantageously, BKMS uses a neutral communication platform to continuously acquire data through data transfer from the corporations and/organizations, for the purpose of gaining knowledge of harmful and forensically activities and white-collar criminal activities.

According to another advantageous feature, the information is based on anonymously submitted information, from which enriched and enhanced data sets are generated using additional company-relevant information. The information can be gathered, processed and enhanced without directly accessing the organizational systems of the requesting and/or the affected party. Depending on the relevance of the anonymously submitted information and/or enlarged data set, a report is assembled from the enlarged data set which is transmitted to a person or group of persons that are identified by the content of the enlarged data set.

This approach is preferred if the monitoring system is operated by an independent provider. The monitoring system, however, can also be used by an affected corporation or by other institutions to process information and data relating to irregularities within the organization, for example by an ombudsman or a designated corruption investigator. In this case, the user of the monitoring system can tailor a report to the specific circumstances.

The BKMS is a knowledge management module, which can be superimposed on the existing controlling, risk, ethics and social management systems, and is therefore for the first time an absolutely essential instrument for the total enforcement and complete implementation of risk, ethics and social management systems. The BKMS is to be understood as representing the first system that, in addition to preventing and protecting the corporate process flows, makes the employees of the corporation or organizations aware of deviations caused by white-collar criminal activities and provides guidelines and Code of Conducts, while simultaneously reducing the liability of the management.

The “Business Keeper Monitoring System” represents a new method which changes and fundamentally improves gathering and investigating of harmful process deviations in corporations and/organizations that could diminish the business value.

It is not only capable to store 24 hours of information which can later be processed by ombudsmen (internal or external), corruption investigators or auditors. The BKMS also ensures the safety of the documentation and enables subsequent evaluation. The tips provided by an informant are stored in the system without changes. All subsequent dialogues with the person processing the information are saved. All data that are appended or added to the information by using external sources (databases and archives) are documented. Moreover, changes of data or activities made by a user (processor) can only be finalized through a conclusive reasoned explanation requested by the system. Moreover, a history runs in the background of the processing application (BI MS) which records precisely the time, the location and the circumstances under which a user (processor) has worked on the case.

The Business Keeper Monitoring System is therefore different from the conventional controlling applications and methods whose disadvantages have been described above. With the invention, it is possible for the first time to not only process financial data, but to gather information and data from all areas of corporations and process flows and the corporate environment, and to evaluate the associated information and data and to transparently indicate value-reducing deviations with a high probability. The invention has an essential advantage in that an interface to systems of the affected and/or requesting corporations is not required for transmitting a message and/or for providing feedback to such message—which would also made no sense, since anonymity should be maintained for the reasons stated above.

Use of the invention mainly benefits the affected and/or requesting corporations by preventing and exposing information about damages or discrepancies in the corporate processes, so as to initiate immediate countermeasures with respect to these activities. The cost and expenses for using the BKMS knowledge management systems are minimal compared to the expected reduction in damage to the organizations (for example, damage to the corporate image, legal steps taken against the management, and cash flow problems have typically any negative effect on the balance sheet of the corporation). In summary, the offered service therefore represents a very efficient and economical instrument for corporations and/organizations.

The BKMS includes for the first time all company employees, as well as corporate partners, customers, etc., in a controlling process. The system is independent of the particular business sector and does not require an interface inside the corporation. The BKMS is the first controlling system that takes into account both the technical and the behavior deviations and can be used to intervene in externally running process deviations.

The invention will now be described in detail with reference to an embodiment that is at least partially depicted in the Figures.

It is shown in:

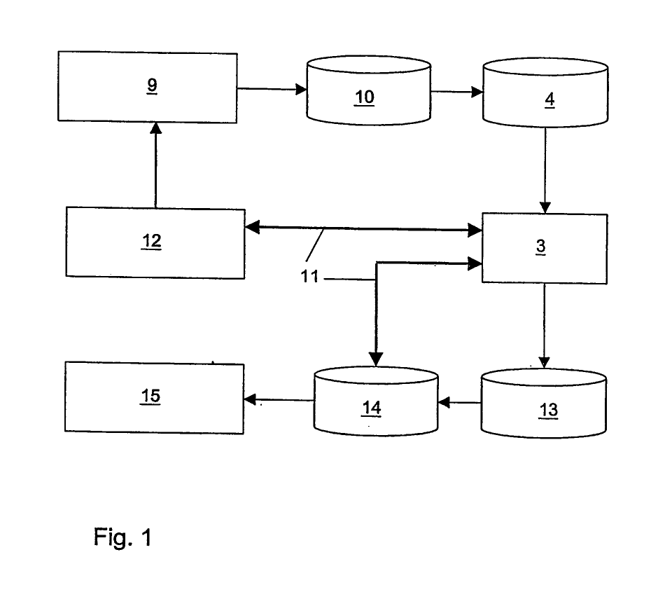

FIG. 1 a diagram of information processing by the BKMS;

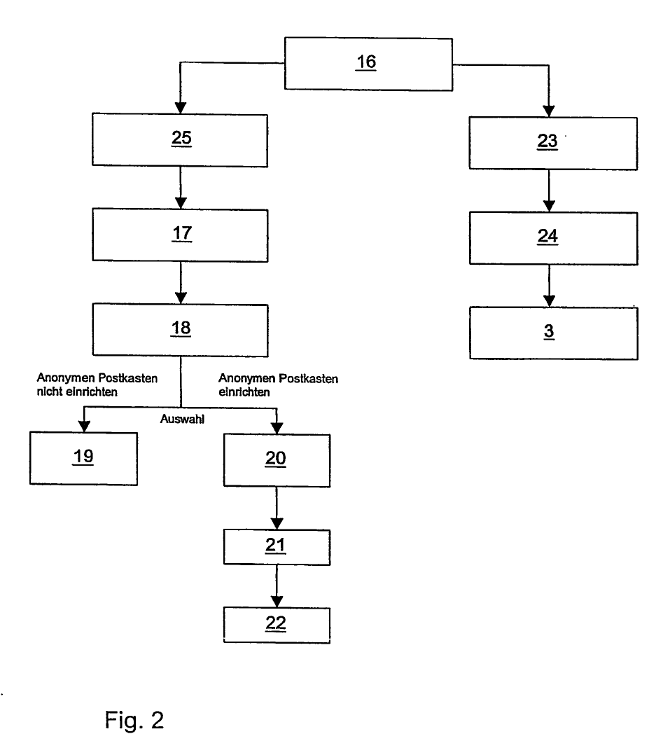

FIG. 2 a process flow diagram for providing information for a dialogue with the informant when using the General Postbox;

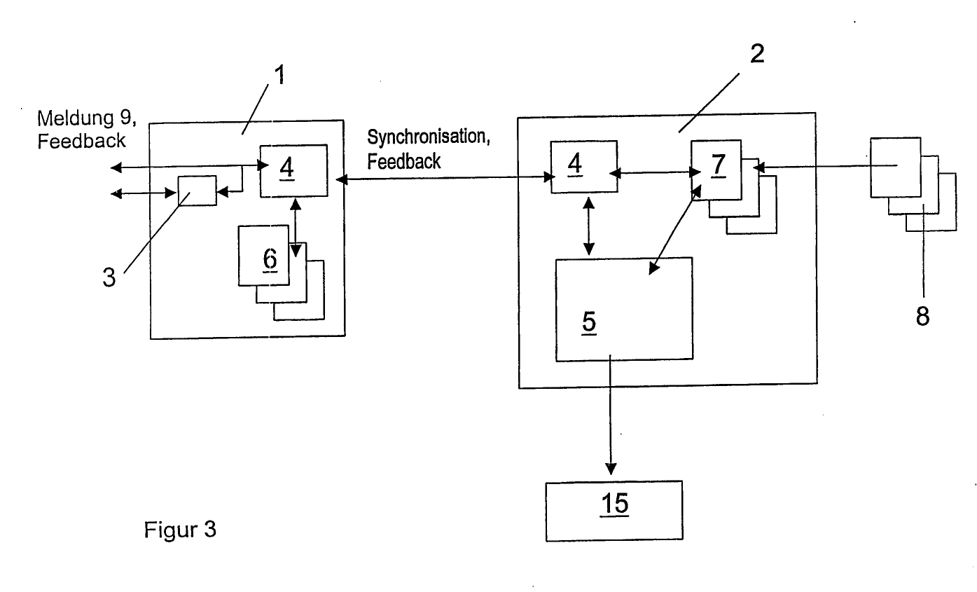

FIG. 3 a basic process flow diagram using the information processing according to the invention;

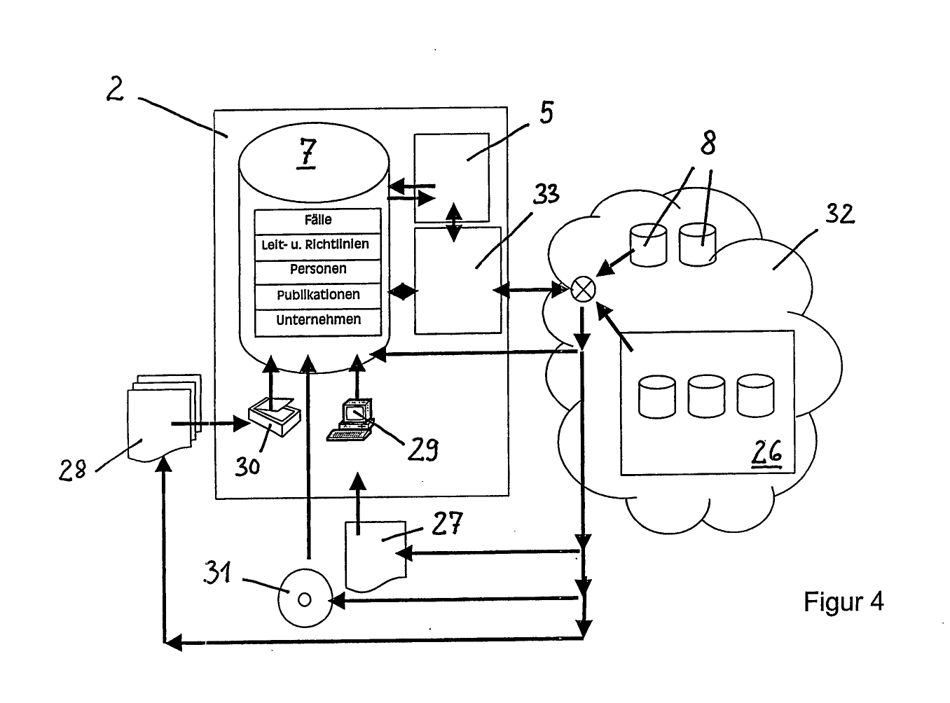

FIG. 4 a detailed diagram for gathering information using the information processing according to the invention;

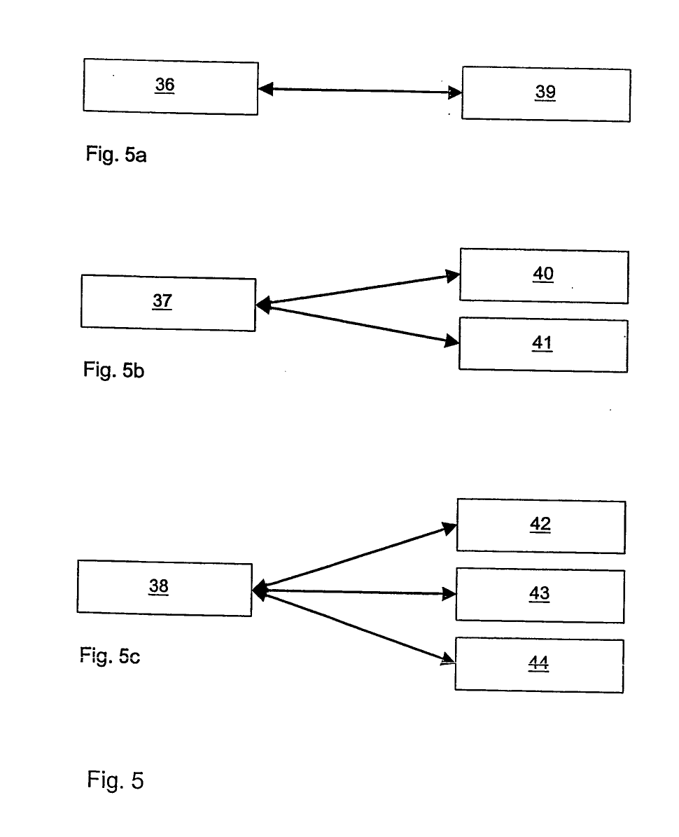

FIG. 5 various input and processing modules of the BKMS;

FIG. 5a input and processing modules available when using the monitoring system as a General Postbox (GP),

FIG. 5b input and processing modules available when using the monitoring system as a Corporate Incidents Postbox (CIP),

FIG. 5c input and processing modules available when using the monitoring system as a Direct Internal Postbox (DIP);

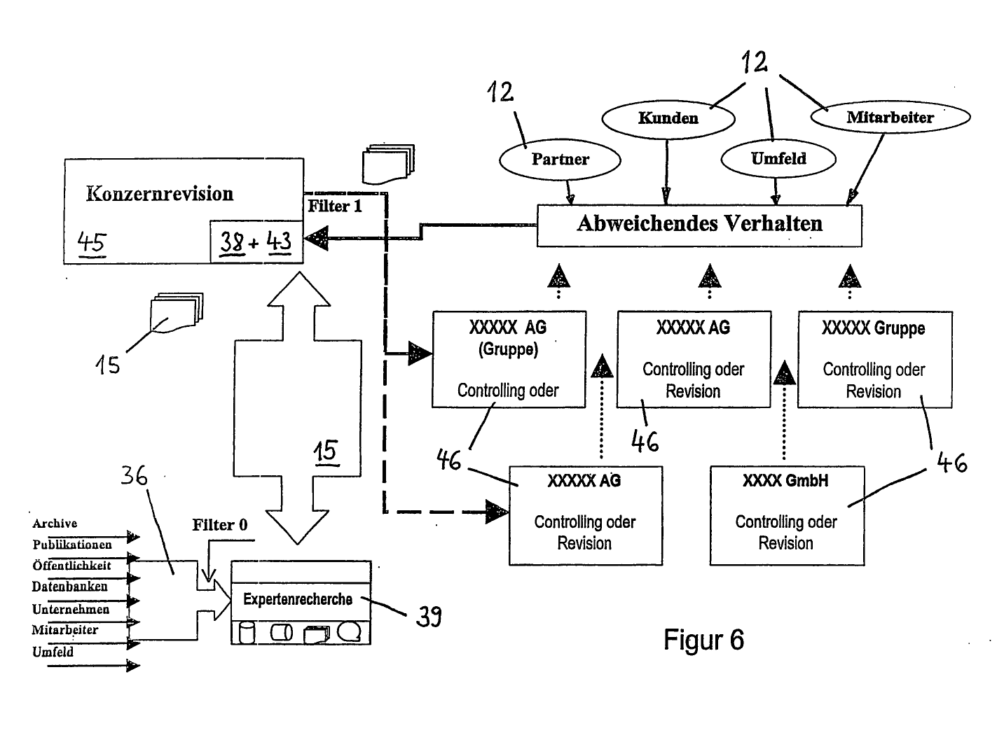

FIG. 6 a diagram of an exemplary embodiment of the information processing according to the invention on a corporate level by using BIMS-C-DIP as a processing module;

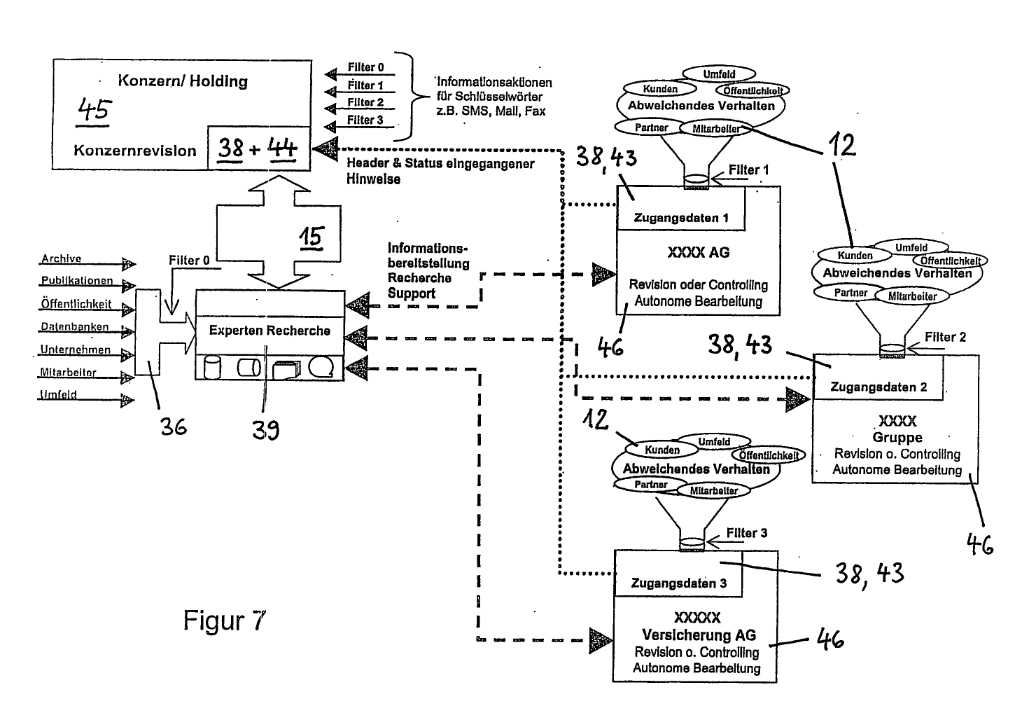

FIG. 7 a diagram for an exemplary embodiment of the information processing according to the invention for a holding system, using both BIMS-C-DIP and BIMS-CC-DIP as processing modules; and

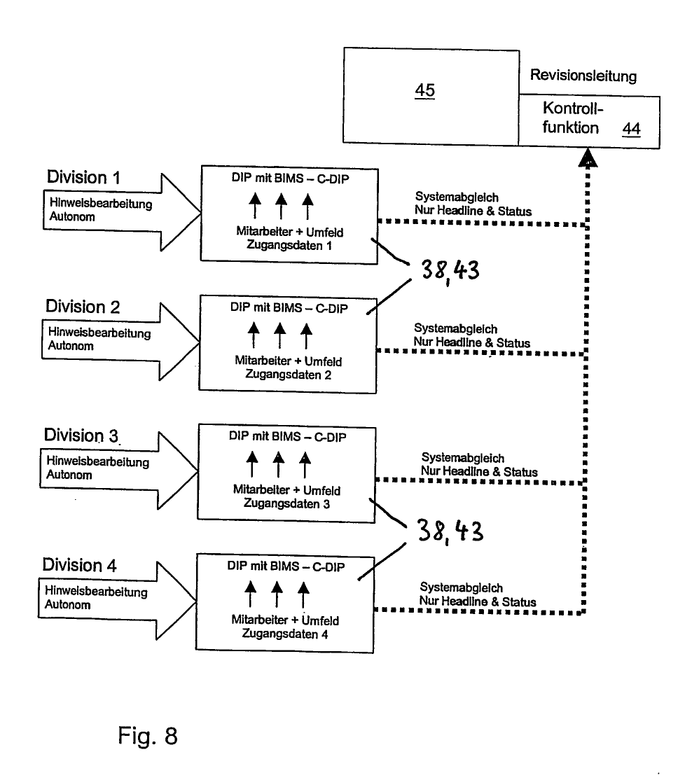

FIG. 8 visualization of an exemplary use of the monitoring system as a Direct Internal Postbox (DIP) by using BIMS-C-DIP and BIMS-CC-DIP as processing modules.

Since it appears sensible to limit prosecution of irregularities or deviations from predefined processes to special areas, the method of the invention will now be described with reference to a monitoring system for incidents of criminal white-collar activities.

The exemplary monitoring system is used, in particular, for rapidly and effectively obtaining plausible, relevant and enriched information about the risk factor of human misbehavior as well as to discreetly forward this documented information. All tips that are received by the monitoring system via a special secure Internet application are subjected to a comprehensive plausibility and relevance check 14. All parameters known to the system, for example preset values and facts from process guidelines or value-oriented agreements, for example from guidelines and behavior codes, are taken into account. Special software can supply correlated information from databases and archives to discover relationships and enriching the information. This can involve both internal databases 7 as well as databases from external providers 8 or automatic queries in special databases 26 containing information data sets, such as Creditreform, Burgel, or Dun & Bradstreet, and other information brokers.

The processing application (BIMS 5) can index data/documents in all external databases and archives, as well as the internal data (publication, corporation and personal databases) and information (documents). In other words, each individual document out of millions of documents is indexed, i.e., each document receives a fingerprint. In this way, each document can be analyzed by the system in several theme classes and retained in the system.

Example: an external or an internal database is previously completely indexed by the system BKMS (e.g., one week in advance). A case now enters the system which relates to a particular load, a truck and its route. The system indexes and takes a fingerprint (several theme clusters) of the case (tip 9) and compares the theme clusters first in its indexed databases.

In the present case, theme clusters can be obtained for a particular load, truck or load. Information related to the case is now obtained by searching the data/documents or the fingerprints of the data/documents of the accessible databases for these themes. The relevance of the data/documents is then determined based on the number of occurrences or based on combinations of themes. The system does here not compare individual words, but rather the themes and the frequency of the comparable themes with the themes of the case. If the system finds relevant data/documents, then the system accesses the corresponding databases and copies the relevant data/documents for that case. In the illustrated example, all companies that have dealt with these loads in the past or are connected with the routine, are added as information to the case. Accordingly, a particular document does not need to contain words that are comparable to those in another document. The theme clusters and the association are recognized. In this way, millions of documents and databases can be compared in a matter of minutes.

In addition, the system can not only process documents 30, but can also compare audio information. The system can be connected to a large number of radio transmitters for analyzing the contributions to the theme clusters, whereby the system finds the themes that are relevant to the case (tip 9). The hit rate is hereby in excess of 95%.

In addition to the investigation, the case can be firmed up by a subsequent dialogue with the informant via the individual anonymous postbox 3.

The checked and processed tips relating to white-collar criminal activities and other critical occurrences in the respective company are provided in the form of a report 15 which can also be issued periodically depending on the agreement with the requesting company. This can be imaged by several differently configured systems, whereby systems are offered which are the sole responsibility of the provider of the monitoring systems. Alternatively, monitoring systems can be used and processed under the exclusive control of the corporate customer (significant embodiments of these different systems will be described in more detail below). In this way, the monitoring system of the invention augments existing risk management systems by providing the hitherto missing element, namely elimination of human error.

The gained transparency then allows the management, like an early warning system, to immediately take measures to prevent or limit damages in the event of deviations from ethical, company-internal or legal guidelines. By using the BKMS, decision-makers in the respective companies do not only abide by legislative requirements (KonTraG, Corporate Governance, Sarbanes-Oxley, etc.), but they redefine the practicability and the importance of active risk management. Informants 12 (whistleblowers) can retain their integrity, eliminate possible negative personal consequences as a result of the assured anonymity, while still contributing to the desire to the goal of a trust-based, honest and transparent corporate culture. As an additional beneficial side effect, alone the rumor that such monitoring system exists can have a significant preventative effect.

Before the individual steps of the method are described in detail, the basic process flow of the exemplary embodiment of the method will be described (see FIGS. 1 and 3).

The messages 9 and information reach with 100% anonymity an information platform on which an anonymous and/or silent electronic postbox 3 can be created, and pass in a first step an automated filter system which will be referred to in the following as OIS (=Outsource Incident System) 4. This information platform, which includes a first (external) database system 6 for the filter system 4, can be established, for example, with an Internet provider as a Web server 10. It is referred to as external data processing unit 1, because it is externally accessible by receiving messages 9, providing feedback and communication 11 with the anonymous informant 12. Computer, databases and similar systems, which are used for carrying out the method of the invention and which are not reachable externally, e.g., via the Internet 32, all referred to as internal systems. After a selection is made in this way and after a test that certain criteria are satisfied, the data are transmitted via an encryption system to the computer center and to an internal database system 7 of the provider. No data from tips are stored on the external data processing unit 1 or on a system that can be accessed via the Internet 32. This outpost is established for security reasons so as to prevent direct access to the internal system from the outside. No information from tips is stored on the external system. The external data processing unit 1 transmits the received messages/tips 9 directly to the internal data processing unit 2, and the messages are filtered on the external data processing unit 1 only by a few fixed routines. The data pass on the internal data processing unit 2 through another selection process, which checks in particular the syntax and correlation of the data using predefinable criteria, which affect further processing of the message 9. In a particular embodiment of the invention, the internal database system 7 can be established as BK-SAPDB system (=Business Keeper SAP Database). Alternatively, instead of at the location of an Internet provider, the external data processing unit 1 can also be installed at the provider of the invention—because this also has a connection to the Internet 32 or to an intranet, so that it will continue to be referred to as external computer system. An application (BIMS=Business Keeper Incident Monitoring System) 5 can also be used as another core element for further processing of the information. The application BIMS 5 collects additional information which are obtained by searching 13 third-party databases 8, from the internal process goals as well as form a multi-level causality analysis or correlation check 14, the results of which are issued as a report 15. The entire exemplary system BKMS (=Business Keeper Monitoring System) therefore provides a hitherto unattainable transparency of deviating processes and guarantees the most reliable and up-to-date relevance of the information for management and industrialists.

The exemplary information processing system can be characterized by the following components, whereby depending on the application of the system the functionality of the components may optionally be reduced or enhanced by supporting applications:

Information and communication platform in the Internet 32 or intranet:
this application guarantees by way of an anonymous area 16 up to 100% anonymity of the informant 12;
enables the creation of an “anonymous and/or silent electronic postbox” 3.

OIS 4 (=Outsource Incident System—external and/or internal):
selection (correlation, syntax check, etc.) and filter system for the received messages;
synchronization of the data.

BK-SAPDB (=Business Keeper SAP Database−internal):
imaging of the information by storage in corresponding special tables of the internal database;
correlation check 14 of the received information.

BIMS 5 (Business Keeper Incident Monitoring System):
access to the BK-SAPDB database:
determination of secrecy levels, syntax, correlation, etc. for the received messages;
information search—optionally interfaces to additional databases of third-party providers 8 and/or to databases 26 of private investigating entities, such as for example Creditreform;
executing several levels of plausibility checks and automated processes;
legal check of criteria and legal processing—catalogues of criminal acts;
checking the relationship between the tip (information) and internal guidelines, code of conduct, publications of the affected entities (corporations, agencies or organizations—customers) etc.;
introduction, review and analysis of information (audio, documents, and data in internal and external databases and archives (a worldwide);
reporting system.

The automated knowledge management system BKMS can, if necessary, be supported by an operator in a dialogue process with respect to transfer of know-how of harmful and/or forensic expert knowledge and decision support according to the plausibility levels, for example, the system has labeled a message as “unclear.”

Since it appears reasonable to restrict the pursuit of irregularities or deviations of presents processes to particular areas, the method of the invention will be described hereinafter in detail with reference to an exemplary monitoring system for white-collar criminal activities (see FIG. 2).

If someone believes to have witnessed an irregularity, which he presumes to be relevant and which should be prevented, but the person is afraid to openly report the incident, then the method of the invention makes it possible to submit this information anonymously. For this purpose, the informant selects, for example, the homepage of a service provider (e.g., Business Keeper) which offers the method of the invention as a service. He then accesses the information and communication platform in the completely anonymous region 16 of the Business Keeper that is provided by the external data processing unit 1. The person can access the information and communication platform via the Internet 32 or via a browser-controlled environment in an intranet or via an internal network environment of a corporation, an organization or another entity (NGO or GO organization).

The informant 12 is therefore initially in the anonymous region 16. If the informant has not yet established an “anonymous and/or silent postbox” 3, then he can enter his message 9 on a message form 17 which is provided to him after activating the “message button” 25.

The informant 12 (external Business Keeper) composes his message 9 on a data structure, the aforementioned message form 17, which is fixed and defined by an input mask, and places the form in the anonymous information and communication platform. No personal information or personal data are required. If the message 9 is generated for the first time, then the informant 12 deals only with the direct anonymous message form. Although the informant 12 is in the anonymous area, he is not in the “anonymous and/or silent postbox” 3. After sending 18 the message 9, the informant 12 is asked by the system if he wants to establish an “anonymous and/or silent postbox” 3 for a follow-up after his message 9 is processed or for answering possible callbacks. If the informant 12 has no interest, then he can leave the system by closing 19 the anonymous area 16. Conversely, if the informant wishes to be informed about further developments in the action, then he can establish 20 an “anonymous and/or silent postbox” 3 by adding a pseudonym and a password. The selected pseudonym is checked by the system for possible usability. After confirming 21 the pseudonym, the “anonymous and/or silent postbox” 3 is established 22. If he has previously generated an “anonymous and/or silent postbox” 3, then he can create the message or information in the “anonymous and/or silent postbox” 3. An already established “anonymous and/or silent postbox” 3 is accessed via a login button 23 which provides an input mask for pseudonym and password in response to a mouse click. After entering 24 the pseudonym and password, one enters the “anonymous and/or silent postbox” 3. The informant 12 (external Business Keeper) can place in the “anonymous and/or silent postbox” 3 one or more new messages 9 relating to additional cases, and make additions to a case or enter a feedback from the Business Keepers. The message 7 can also be placed on an intranet network of a corporation, administration or organization (NGO or GO) instead of the Internet 32. This demonstrates once more the most important aspect of the invention, which distinguishes the invention from all other conventional solutions: if the content of a message has to be clarified, an inquiry is made without violating the anonymity of the informant. This is not guaranteed in any other conventional system.

After entering the predefined, fixed data structure, the OIS system 4 (Outsource Incident System) is activated. The OIS 4 represents a technique by which all information and text is automatically and schematically checked with respect to content, quality, possible correlations and its components. Information in the messages 9 is, for example, checked for syntax, compared with legal texts, compared with regulations of different kind and relationship with a collection of different topics or keywords. The so determined and evaluated components of the message 9 are associated with certain classes by a downstream filter system and confirmed accordingly. Different routines are initiated in conjunction with the classification and/or confirmation of the components of the anonymous data that affect deletion and/or forwarding of the message 9 and/or activation of secrecy levels. Individual components of the message 9 can also be deleted or forwarded, without human intervention. The informant 12 (external Business Keeper) receives immediately information about the results of his message 9. The OIS technique 4 thereby eliminates undesired messages 9 or data content and guarantees that a concentrated desired information and only a predefined quality and selection of the information is forwarded to another database.

After receiving a tip in the external data processing unit 1 of the monitoring system, the processing module OIS 4 automatically searches for the corporation-internal or institution-internal guidelines, code of conduct and legal texts and compares these with the characteristic features contained in the tips/messages. The OIS 4 then adds these to the tip if detecting a relationship with the message. All legal texts (criminal law, bankruptcy law), company-internal guidelines, are entered into a database of the system ahead of time and categorized according to attributes and causality sequences. The system can add additional information to a tip (case) which can then support the decision-making. The company-internal or organization-internal guidelines, behavior codes, etc., are separately entered for each company and each organization and are provided with special attributes and causalities. In order to correlate a tip with an offense, a large portion of or the entire criminal law, bankruptcy law, property law and the like (large number of offenses) is stored in the databases of the monitoring system and processed according to the specific aspects and causalities of each individual offense.

For example, data and texts relating to sexual harassment, mobbing, regulatory requirements, other conditions or other predefinable themes, etc., can be extracted with the help of the OIS technique 4. Accordingly, this technique can be applied to directly or indirectly descriptive texts and can retrieve with additional syntax checks predefined quality standards from an anonymous message 9. The complexity of this OIS technique 4 requires a new information technology, with which the relevance of an anonymous information can be determined and a new and predefinable information quality can be achieved.

In the OIS system 4, action filters can be programmed and adjusted in addition to the aforedescribed filters and other functions. Actions in the form of an early warning system are automatically carried out depending on the type of the message, words, word correlations and theme areas.

The functionality of this action filter is illustrated based on the following example. A customer, for example an airport, processed its incoming tips internally by using its own internal ombudsman. A tip which is described a dangerous situation is received by the management (e.g., ombudsman) outside the business hours at 11 PM. The OIS 4 recognizes the content of the message and sends a defined code to one or several mobile telephones or fax machines, e-mails or informs a security service, which immediately informs the responsible persons and urges them to look into the system BIMS 5. The user can adjust and change to whom a code for specific tips is to be sent. The incoming tip 9 itself is not sent, but rather only the associated code. It serves as an early warning system for very explosive tips about activities that endanger life or property, and where action has to be taken immediately. Thousands of codes for thousands of defined tips can be defined.

With the OIS technique 4 and an OIS quality check, a tip 9 can run multiple times on different server platforms (data processing units) located at different sites; in other words, a tip 9 or a case can be processed multiple times on one or on different computers/server platforms by the OIS system 4.

The informant 12 can also enter via a previously created “anonymous and/or silent postbox” 3 additions, new tips, input responses, which are again checked by the OIS system 4 and optionally appended to an earlier tip 9. Alternatively, a new case can be opened.

The OIS system can enlarge its boundary conditions and the relevance of quality checks with the help of connections to databases and information centers or networks, to which it can then connect.

Generating an “anonymous and/or silent postbox” 3 via the informant 12 (external Business Keeper).

The informant 12 (external Business Keeper) can, if he does not already have an “anonymous and/or silent postbox” 3, create an “anonymous and/or silent postbox” 3 by providing a pseudonym and password. However, this is not absolutely necessary; he can also place a tip 9 directly in the anonymous area without an “anonymous and/or silent postbox” 3. However, creating an “anonymous and/or silent postbox” 3 makes sense, because the informant 12 receives via the postbox feedback, which may be required to further resolve the case, or to receive information about the processing status of the tip 9 (see also FIG. 2).

A tip 9 received in the anonymous information and communication platform can be deleted by the OIS system 4 when certain criteria are not met or certain predefined boundary conditions are not satisfied. The automatic result from the quality check, which depends on the parameters in the OIS system 4, is once more selected in the OIS system 4 according to deletion or forwarding and processed accordingly, for example by deleting the entire message or partial information or by forwarding the same.

The result of the OIS check is immediately transmitted to the informant 12 (external Business Keeper) if information is fully or partially deleted, forwarded, or later transmitted via the “anonymous and/or silent postbox” 3. This information continues to be transmitted on an anonymous basis to the informant's “anonymous and/or silent postbox” 3 or directly via the individual input mask of the anonymous information and communication platform. The result can then be immediately transmitted in the anonymous region 16 or later optionally stored in the “anonymous and/or silent postbox” 3 of the informant 12. It should be mentioned again, that for security reasons no actual data about the tip are stored on the external system. In a preferred embodiment, callbacks are also provided on the internal data processing unit 2 and only transmitted to the external data processing unit 1 (encrypted), when the informant 12 has logged in the “anonymous and/or silent postbox” 3.

After passing through the OIS system 4, a filter function is responsible for setting the secrecy levels and defining the relevance of information. In this automatic routine, the areas of responsibility for further processing of the tip 9 and/or the information are defined. The tips 9 can be separated into several secrecy levels, such as “confidential”, “secret”, “extremely secret”, etc.

Up to this point, all processes are running on an external data processing unit 1 that is specifically set up for receiving the data. After the aforedescribed selection, which includes for example evaluation and/or classification, the result of the OIS check is transmitted to the BK-SAPDB system, after sorting with respect to relevance and/or secrecy. The information which is preselected and defined according to a fixed quality standard and which has not been deleted by the OIS system 4, are stored after the transmission in one or several (internal) databases 7, which are located in an internal data processing unit 2 which can further process the tips 9.

This data transfer is encrypted to provide data security and confidentiality of the provided tips.

Since the external data processing unit 1 (the external server), on which the anonymous information and communication platform runs, is accessible to outsiders, for example via the Internet 32, there is always a risk that data are accessed without proper authorization. The internal databases 7 are not accessible from the outside and therefore guarantee an almost complete protection from misuse of the data.

The application BIMS 5 (Business Keeper Incident Management System) receives the tip 9 with all information and results from the BK-SAPDB, which is a part of the internal database system 7. The information is automatically checked and correlated with the existing data of the BK-SAPDB (see FIG. 4). The system checks for possible links to other cases and information, which are then appended to this actual case or tip 9. This check of the BIMS system 5 processes in a first step only information from the existing data or datasets from the BK-SAPDB database. Cases, corporations, results, etc., from previous messages or information (financial statements 27, prospectus about the company, newspapers/magazines 28 or other publications, etc.), which are entered in the system directly via a PC 29 or a scanner 30 or read from data carriers, such as diskette, CD 31 and the like, are associated with the new tip. Optionally, the BKMS can create an one-sided interface to other third-party corporate or organizational databases 8 in the first level for checking, thereby allowing an evaluation of the datasets with information from third-party databases 8 in addition to using the internal BIMS system 5. Particularly powerful for the data evaluation (with a hit rate of more than 95%) is the aforedescribed indexing of data/documents and the formation of theme clusters, which are performed by additional tools 33 of the system. Also mentioned should be the evaluation of information that are provided by information bureaus (Creditreform, Burgel, Dun & Bradstreet, etc.).

To optimize the application of the monitoring system, the tip 9 can be checked and/or evaluated in several levels. A first check is performed immediately after sending the tip 9 on the external data processing unit 1—the external server. This may only involve a small (external) database 6 and separate tips 9 by performing a simple pattern comparison with the terms that prove that the tip 9 is absolutely unreliable, or indicate that the monitoring system is not responsible for the transmitted case. Depending on the evaluation of the tip 9 by the BIMS system 5—e.g., relevance or secrecy level—an additional level of the check can be automatically initiated. Advantageously, by involving databases that have not been used so far, the tip 9—which is already augmented with additional information—is checked in detail, resulting in a stepwise increase in the reliability of the original message. In analogy to comparable approaches, these levels can be referred to, for example, as “Compliance Center” 34, “Profile Center” 35, . . .

The additional checking level in the application BIMS 5 can, for example, check the initial plausibility of the tip 9 and the results, assemble further information in the case or change the secrecy level of the tip 9. Such level would be comparable to a Compliance Center. In the plausibility check, the information data supplied by the informant 12 are automatically compiled with the data bases of the BIMS system 5, which also checks their causality. In each plausibility level, a decision is made about further processing and relevance of the tip 9.

For obtaining information, additional internal or third-party databases (7, 8) can be used depending on an assessment and evaluation of the tip or the case. The resources for processing to tip 9 or the case can be adapted to its importance. The BKMS system technically only accesses databases 8 of third-party providers from one side. This prevents access to internal data from the outside.

Depending on the level of the check, the case can be automatically processed by the system according to its legal relevance. In the application BIMS 5, a catalog of offenses provides the platform for a representation that can be legally evaluated.

Depending on fixed plausibility levels and information that can be legally evaluated (catalog of offenses), the message 9 results in a report 15. The report 15 is created by the system BIMS 5 and can be provided differently depending on information content and plausibility level as well as customer structure. The addressee or addresses of the report 15 can be optionally deduced from the data appended to the original tip.

Different versions of the report are differentiated by, for example, information content, structure, customer structure, recipient of the information, etc.

When using specifically created monitoring systems (for example Corporate Incident Postbox 37 (CIP) or Direct Internal Postbox 38 (DIP) (see below)), the data and information can also be evaluated by the affected companies or institutions, which then can also create a report 15.

In order to obtain the BK Integrity Report from process tips about white-collar criminal activities in the respective organization, only two steps are required:
Determining a contact person in the organization who receives the processed tips,
Making the employees and business partners aware through announcements.

The BKMS is also a central element of a comprehensive integrity management designed to have a lasting effect. The components listed below significantly promote the successful use and effectiveness of the method of the invention:
Clarifying and determining of the desired behavior in the corporation,
introducing and communicating internally and externally the integrity-relevant approaches,
implementing the integrity-relevant approaches,
monitoring conformance with the agreed-upon rules, behavior and value patterns with the monitoring system of the invention,
evaluation during the process.

After a decision has been made to further processing the tip 9, the tip 9 or the case are identified accordingly. For example, it can be indicated
if the tip 9 is to be submitted to another checking level,
if it is to be stored in a database as information for potential new tips 9,
if a callback to the informant 12 is required,
if the information is sufficient for creating a report 15, or
if the tip 9 is to be deleted because of lack of relevancy, or because a tip 9 does not fall under the responsibility of the monitoring system for white-collar criminal activities.

In this case, too, additional internal or third-party databases 7, 8 of other database providers can be used for gathering information, and (one-sided) interfaces can be created.

If the monitoring system generates a feedback, then the informant 12 (external Business Keeper) can send immediately or after several days a response and with that additional information to the BKMS system via his “anonymous and/or silent postbox” 3, while still remaining completely anonymous. The completely anonymous correspondence with the informant 12 is an additional function in the application of the BKMS.

The monitoring system of the invention provides alternatively selectable input and processing modules that provides the informant 12 and the corporation with a specific information sphere and a specific information depth. The combination of an input module and a processing module form the different embodiments of the monitoring system of the invention. The BIMS 5 provides the platform for further processing of the tip through dialogue with the informant 12 as well as combination and evaluation of information. The different variations are differentiated by their areas of application, their functionality and processing technology.

1. Input module: General Postbox (GP)

General, anonymous and/or silent mailbox 3

2. Input module: Corporate Incident Postbox (CIP) 37

Case-specific, anonymous and/or silent mailbox 3

3. Input module: Direct Internal Postbox (DIP)

Company-internal, anonymous and/or silent mailbox 3 of the, e.g., ombudsman

As mentioned above, in addition to the searching, processing and evaluation technology in the BIMS 5, each anonymous informant 12 can be asked questions about details of the case via the anonymous and/or silent postbox 3, as well as for a plausibility and relevance check 14. This depends on the selection of the specific embodiment of the monitoring system (input and output module) and is performed under the auspices of the customer center or by the provider of the method of the invention. If the customer's company is responsible, then a qualified group of persons from the audit department, company security or legal department as well as, for example, an ombudsman (internal or external) or a fraud investigator should be selected.

If necessary, a separate platform with a stand-alone login routine (anonymous region) can be provided to a requesting corporation for obtaining from certain groups of persons (internal and external) information about individual cases. A case-related monitoring process is initiated. The corporation supplies the case-related login routine to one or more groups of persons in the corporation or corporate environment.

Enrichment with Additional Data by Using Special Technologies in BIMS 5

BIMS 5 10 provides additional evaluations for substantiating the case and aid in the decision-making process:

a) Indicating and Searching Publications Relating to Affected Corporations, Persons, Process Flows and Comparable Offenses:
BIMS 5 uses a technology that makes it possible to compare themes of a tip—tip 9—with millions of documents from archives and databases. Each document (also the tip) is imaged based on the frequency of occurrence of certain words and word combinations in theme clusters (“electronic fingerprint”). The content of each tip 9 is indexed and linked with documents from databases and archives depending on its attributes and word connections as well as the occurring themes (see, for example, the above description relating to theme clusters “load”, “truck”, “route”). Audio and/or graphic information can also be processed by determining theme clusters for the audio recordings or linking graphic patterns (for example, logos) with certain words and/or theme clusters. The hit rate can reach 95%.
   b) Catalog of Offenses:

Each tip with the enhanced information can lead to a criminal act. The system evaluates factual attributes related to a narrow selection of criminal acts from the legal catalog of offenses. The applicable paragraphs are listed to aid in the decision. The system determines based on the factual attributes the legally defined offense or limits the factual attributes to one, two or more possible offenses. The legal causalities (for example target of the offense, the offense itself and the means used to carry out the offense, etc.) are taken into account by the system in its analysis and evaluation.

c) Infractions Against Company Guidelines, Rules and Behavior Codes:

The company-specific guidelines, rules and behavior codes are entered into the system BIMS 5 with defined fixed attributes. Each received tip is in addition evaluated by the system with respect to deviations from the legal standards and the company-internal rules. The detected deviations are listed to aid in the decision.
   d) Early Warning System for Explosive Tips:
A function is imaged in the individual modules which is applied directly when a tip is received from an informant 12 (whistleblower). Words or word combinations predefined by the company result in an immediate action. For example, when the word “Sabotage” is received, an action could follow which involves sending a SMS, a fax or an email to one or several responsible persons with a code or the indication to a look immediately at the system. The actions as well as the input of keywords are unlimited and can cover virtually any possibility. This functionality can also be applied, for example, to airports and other important public institutions, events, where countermeasures are automatically initiated immediately, i.e. without additional levels of checks, in response to specific words or word combinations, such as explosive, weapons, attack or the like.

Specific situations using the appropriate embodiments of the monitoring system will be described in the following sections.

The General Postbox (GP) 36 (see FIG. 5a)

The GP 36 is publicly accessible and enables all employees of the company or other potential information carriers of the corporate environment to anonymously submit relevant tips/messages 9, regardless of the time and location, relating to white-collar offenses or other counterproductive activities.

An individual “anonymous and/or silent postbox” 3 is provided to the informant 12 of the first tip/message 9. This enables the informant 12 to follow the case, to conduct a dialogue with the provider of the monitoring system, to submit additional information in the case and to receive feedback. Absolute anonymity is guaranteed at all times.

The GP 36 can only be combined with the processing molecule BIMS BK 39 which as the supplier of the inventive monitoring method receives as well as processes and forwards the tips to the respective requesting party in the context of the report 15.

The informant 12 (external Business Keeper) from the aforedescribed group of persons then accesses a stand-alone information and communication platform within a completely anonymous area. Again, the possibility exists to create an “anonymous and/or silent postbox” 3 which enabled both feedback and communication dedicated to this case.

In this way, information relating to specific cases can be obtained especially for that case from a selected group of persons.

One particular aspect of this system is that the double-blind security feature in conjunction with the technical implementation provides a confidentiality basis for specific cases which should entice an observer to come forward with information.

This so-called Corporate Incident Postbox (CIP) can be created by the BKMS for selected individual cases, e.g. cases with particular relevance for the corporation, or cases where the facts are difficult to uncover, and aid in the investigation.

A separate stand-alone platform is hereby generated for a single case. The BKMS facilitates a case-related search with a case-specific report.

The login routine initiates a stand-alone BKMS process which passes through the known systems OIS 4 and BIMS 5.

The informant 12 (external Business Keeper) can also receive feedback by creating an—optionally separate—“anonymous and/or silent postbox” 3 or communicate with the monitoring system.

The CIP enables the requesting company to determine particular deviations or deficits in the company-internal process flows and/or to specifically search for particularly harmful acts.

The BKMS can also automatically create statistical data covering the individual requesting companies and relating to the economically relevant deviations for those companies.

To deal with the aforedescribed situation adequately, two other embodiments of the invention can be employed.

The Corporate Incident Postbox (CIP) 37 (see FIG. 5b)

CIP 37 is not publicly accessible. It is intended to efficiently deal with damages that have already occurred or to optimize the process in a concrete case. Access data are communicated to selected persons, which allow the persons to read corporate information and factual information on the case-specific web site and to submit tips.

The communication with each individual informant takes place via the individual anonymous and/or silent postbox while maintaining the complete anonymity of the informants 12 (whistleblowers).

The processing molecule BIMS-CIP 40 is used to forward to the checked and qualified information in the form of a report 15 directly and exclusively from the provider of the inventive method to the requester. However, an additional processing module BIMS-C-CIP 41 can also be employed.

When selecting the processing module BIMS-C-CIP 41, the responsibility and the processing is taken over by the affected corporation without direct involvement or knowledge of the provider of the inventive method. This is basically possible if the provider assures proper handling of the information.

The Direct Internal Postbox (DIP) 38 (see FIG. 5c)

DIP 38 is not publicly accessible. It is an internal information and communication platform for the ombudsman, or the audit or corporate safety department of the company. Employees of a company and other outsiders receive access data which allow them to anonymously contact their ombudsman via the company-specific web site. Information from the company side (e.g., guidelines) or questions can be communicated and an anonymous dialogue with the informant can be established.

Tips and information received in the DIP 38 can be processed with three different processing modules: BIMS-DIP 42, BIMS-C-DIP 43, BIMS-CC-DIP 44. When using BIMS-DIP 42, the tips and information are processed and answered by the provider of the inventive monitoring system, whereas when using BIMS-C-DIP 43, the tips and information are processed and answered directly by the ombudsman, without involvement of the provider of the inventive monitoring system. The processing module BIMS-CC-DIP 44 was developed specifically for a corporate holding structure. With this modification, each division 46 of a company receives an autonomous DIP 42, whereby the company headquarter or holding headquarter 45 receives only the subject line (header) and the status of the tips received in the autonomous division 36 for acknowledgment and control (a simple schematic diagram is shown in FIG. 8).

The application of the processing module BIMS-C-DIP 43 is illustrated in more detail in FIG. 6. A corporation desires to investigate, for example, irregularities that it has received (not necessarily anonymously) in an unspecified form. To investigate such irregularities, the affected corporation has the option to use the processing module BIMS-C-DIP 43 which it can employ in its headquarter. This is indicated if deviating acts have to be investigated in the divisions 46. The corporation can then make access data available to a selected group of persons (employees or external parties, such as partners, customers and to like) which are suspected of having knowledge of the acts. The tips 9 entered by this group of persons in the system via the “anonymous and/or silent postbox” 3 are searched for irrelevant information in a first filter which can be created specifically for that corporation. The relevant tips 9 which have passed through the filter, can now be evaluated company-internally with the processing module BIMS-C-DIP 43. This also includes compilation of reports 15, which are created in this case internally and not by a third provider of the monitoring system.

Processing of the information from the company-internal monitoring system can also be supported by a third, external and independent provider of the monitoring system. For example, an agreement can be reached between the corporation and the third provider of the monitoring system that, for example, the third provider of the monitoring system transmits to the corporation for a defined list of keywords or themes the related information received via the General Postbox 36, which are then made available to the corporation in addition to the tips received from the selected group of persons.

FIG. 7 illustrates the situation where the divisions 46 of a corporation employ their own processing modules BIMS-C-DIP 43, which the divisions 46 can use to process deviating behavior in their direct environment. The divisions 46 provide their own access data and assume responsibility for processing received tips 9. Only the header, optionally with the status of the received tips, are forwarded to the corporate headquarter. This modified information processing according to the invention can advantageously be employed if the divisions 46 represent areas having specific characteristics, such as a manufacturing department, a house bank and to like, or divisions 46 with particular regional attributes. In analogy to the aforedescribed example, the corporate headquarter and/or divisions 46 can be supported by a third provider of the monitoring system, which supplies additional information compiled and processes from the messages 9 received by the third provider.

The method and system of the invention can not only be used to detect the irregularities (harmful acts), but also to communicate complaints or proposals for improvements. In this case, informants 12 or customers or other groups of persons supply tips or messages 9 relating to a process, a product and/or to process improvements, or to a complaint to the BKMS, which hence can also be used as a complaint and/or optimization system.

The essential attributes of the three aforedescribed variants of the embodiment can be summarized as follows:

General Postbox 36 (GP):

public,

dialogue with informant,

scanning of the corporate environment,

substantial search capability,

substantial information content,

processed and refined data,

report from the provider of the monitoring system.

Corporate Incident Postbox 37 (CIP):

case-specific,

access data,

dialogue with informant

selection of individual corporate areas

limited usage

management by: ombudsman, audit, internal security, trusted person,

documentation by the customer company or the provider of the monitoring system.

Direct Internal Postbox 38 (DIP):

company-internal,

access data,

dialogue with informant,

search and evaluation,

unlimited usage,

management by: ombudsman, audit, internal security, trusted person,

documentation by the customer company or the provider of the monitoring system.

CIP 37 and DIP 38 can also be used by the customer with the help of a qualified employee, ombudsman (internal or external), audit, corruption investigator or another legal entity. The user himself prints the report.

The customer can also request to have the CIP 37 and DIP 38 processed by an (external) neutral provider of the monitoring system. In this case, the customer provides the access data only to the group of persons or to the company or the company environment. The provider processes and evaluates the incoming tips.

The invention is not limited to the aforedesribed embodiments, and additional modifications and variations can be realized by combining and modifying the aforedescribed means and features, without leaving the scope of the invention.

### LIST OF REFERENCE CHARACTERS

1 external data processing unit
2 internal data processing unit
3 anonymous and/or silent postbox
4 OIS (=Outsource Incident System), Filter system
5 BIMS (=Business Keeper Incident Monitoring System)
6 external database system
7 internal database system
8 database(s) of third-party suppliers
9 tip, message
10 Web server
11 Communication with the informant
12 informant
13 search
14 plausibility analysis and/or correlation check
15 report
16 anonymous area
17 message form
18 sending a message
19 closing the anonymous areas
20 create “anonymous and/or silent postbox”
21 confirmation of the pseudonym
22 creation of the “anonymous and/or silent postbox”
23 login button
24 input pseudonym and password
25 “message button”
26 databases of investigation bureaus
27 balance sheet reports
28 newspapers/magazines
29 PC
30 scanner
31 CD
32 Internet
33 additional tools
34 compliance center
35 profile center
36 general postbox (GP)
37 corporate incident postbox (CIP)
38 direct internal postbox (DIP)
39 BIMS-BK
40 BIMS-CIP
41 BIMS-C-CIP
42 BIMS-DIP
43 BIMS-C-DIP
44 BIMS-CC-DIP
45 company headquarter, holding headquarter
46 corporate division
   Figure Legend
   (Terms that Appear Several Times in the Same Figure or Terms that Appear in More than One Figure are Only Listed Once)

FIG. 2

| | |
|---|---|
| Anonymen Briefkasten nicht einrichten | Don't create anonymous postbox |
| Auswahl | Selection |
| Anonymen Briefkasten einrichten | create anonymous postbox |

FIG. 3

| | |
|---|---|
| Meldung 9, Feedback | Tip 9, feedback |
| Synchronisation, Feedback | synchronization, feedback |

FIG. 4

| | |
|---|---|
| Fälle | Cases |
| Leit u. Richtlinien | Guidelines, instructions |
| Personen | Persons |
| Publikationen | Publications |
| Unternehmen | Companies, corporations |

FIG. 6

| | |
|---|---|
| Konzernrevision | Corporate audit |
| Publikationen | Publications |
| Öffentlichkeit | Public |
| Datenbanken | Databases |
| Unternehmen | Companies, corporations |
| Mitarbeiter | Employee |
| Umfeld | Environment |
| Expertenrecherche | expert search |
| Kunden | Customer |
| Abweichendes Verhalten | Deviating behavior |
| Controlling oder Revision | Controlling or audit |
| Gruppe | group |

FIG. 7

| | |
|---|---|
| Konzern/Holding | Corporation/holding |
| Informationsaktionen für | Information actions for keywords, |
| Schlusselwörter, | e.g., SMS, mail, fax |
| z.B. SMS Mail, Fax | |
| Header & Status eingegangener | Header & Status of |
| Hinweise | received tips |
| Zugangsdaten | Access data |
| Revision oder Controlling | Audit or controlling |
| Autonome Bearbeitung | autonomous processing |
| Versicherung AG | Insurance Co. Ltd. |
| Informationsbereitstellung | Providing information |
| Recherche | search |
| Support | support |
| Experten Recherche | Expert search |

FIG. 8

| | |
|---|---|
| Hinweisbearbeitung | Tip processing |
| Autonom | autonomous |
| DIP mit BIMS-C-DIP | DIP with BIMS-C-CIP |
| Mitarbeiter + Umfeld | employee + environment |
| Zugangsdaten | access data |
| Revisionsleitung | Audit management |
| Kontrollfunktion | Control function |
| Systemabgleich | System adjustment |
| Nur Headline &Status | only headline & status |

1. Method for processing information in monitoring systems for ethics, risk and/or value management,
characterized in that
data received by a computer system are checked for predefined patterns and evaluated and/or classified,
the data are erased or provided for further processing depending on the evaluation of the data, further processing of the data comprises the following steps:
evaluating the data,
depending on the results of the data evaluation, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

2. Method according to claim 1,
characterized in that
an anonymous communication channel is established that is linked to the received the data by a special access code.

3. Method according to claim 1,
characterized in that
the data are received and the data are further processed on different data processing units of the computer system.

4. Method according to claim 1,
characterized in that
the an external data processing unit (1) that is established for receiving the data can be accessed via the Internet (32) and/or an intranet.

5. Method according to claim 1,
characterized in that
for inputting the data via the Internet (32) and/or intranet and input mask is provided to the person entering the data (informant) (12), which allows anonymous data input and establishment of an anonymous and/or silent (3) mailbox.

6. Method according to claim 5,
characterized in that
the communication between monitoring system and informant (12) is carried out via the anonymous and/or silent mailbox (3).

7. Method according to claim 1,
characterized in that
at presettable time intervals, a synchronization occurs between an external database or databases existing on the external data processing unit(s) (1) and an internal database or databases (7) provided on an internal data processing unit or units (2) used to further process the data, in that the received data are transmitted by the external database(s) (6) to the internal database(s) (7) and subsequently erased on the external database(s) (6).

8. Method according to claim 1,
characterized in that
the data transfer between the data processing units of the computer system is at least partially encoded.

9. Method according to claim 1,
characterized in that
the patterns used for evaluating and/or classifying the received data comprise
legal terminology and/or
text passages from legal requirements and/or
a catalog of offenses and/or
text passages from terms of contracts awarded by companies.

10. Method according to claim 1,
characterized in that
the received data are evaluated based on the patterns identified in the data.

11. Method according to claim 1,
characterized in that
the received data are classified based on the patterns identified in the data.

12. Method according to claim 1,
characterized in that
actions are automatically carried out depending on the evaluation and/or classification of the received data, whereby it is determined with an action filter if an action is carried out or not carried out or in which manner an action is carried out.

13. Method of claim 12,
characterized in that
an action comprises
sending a message via SMS, fax and/or e-mail and/or
sounding an alarm and/or
other (counter-) measures.

14. Method according to claim 1,
characterized in that
the received data (tip (9)) are evaluated with respect to
significance of the damage and/or
plausibility of the tip (9) and/or
correlation with presettable criteria and/or
information contained in the tip (9) about companies, organizations or persons and/or
information contained in the tip (9) relating to trades and business sectors and/or
legal considerations and/or
statutory requirements and/or
a required secrecy level and/or
publicly accessible publications.

15. Method according to claim 14,
characterized in that
the correlation of the data is determined with respect to
other cases and/or
other tips (9) and/or
corporate and/or administrative guidelines and/or
guidelines and/or
international requirements and/or regulations and/or
requirements from companies awarding contracts and/or
persons and/or
companies and/or
trades.

16. Method according to claim 1,
characterized in that
external and/or internal databases (6, 7) and/or databases of third-party suppliers are queried for determining additional data.

17. Method according to claim 1,
characterized in that
received data and/or other data or documents are linked through indexing with the subject matter clusters.

18. Method according to claim 1,
characterized in that
the other data comprise audio data.

19. Method according to claim 1,
characterized in that
the sender of the received data receives via a feedback system information about the processing status of the received data.

20. Method according to claim 1,
characterized in that
the steps of further processing the data are carried out several times on different quality and/or complexity levels.

21. Method according to claim 20,
characterized in that
a special database query is associated with each quality and/or complexity level.

22. Method according to claim 1, characterized in that
the data pass through at least one filter system before and/or during further processing, which filter system(s) associate(s) the data or components of the data with certain classes and/or declares the data or individual components of the data.

23. Method according to claim 1,
characterized in that
further processing of the data is supported by an operator of the computer system in a dialogue process.

24. Method according to claim 1,
characterized in that
a report is generated for transmitting the data, wherein the information content and/or information structure of the reports is adapted to the plausibility level, the customer structure and/or the recipient(s) of the information.

25. Method according to claim 1,
characterized in that
a targeted detailed statistics is generated for harmful and/or forensic actions related to white-collar crime.

26. Arrangement with a processor which is configured so that information can be processed in monitoring systems for ethics, risk and/or value management, such that data received by a computer system are searched and evaluated and/or classified with respect to predefined patterns,
the data are erased or provided for further processing depending on the evaluation of the data, further processing of the data comprises the following steps:
evaluating the data,
depending on the results of the evaluation of the data, determining associated additional data by a database query,
depending on the results of the preceding steps, generating a data set that is enlarged by the associated data,
depending on the results of the preceding steps, transmitting at least a portion of the enlarged data set to a person or persons identified by the content of the enlarged data set.

27. Arrangement according to claim 26,
characterized in that
the arrangement comprises means for data exchange with the Internet (32) and/or an intranet and/or another data transmission network.

28. Computer program product comprising a computer readable storage medium with a program stored thereon, which enables a computer, after the program is loaded into memory of the computer, to process information in monitoring systems for the ethics, risk and/or value management, whereby data received by a computer system are searched and evaluated and/or classified according to predefined patterns,
the data are erased or provided for further processing depending on the evaluation of the data, further processing of the data comprises the following steps:
evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

29. Computer-readable storage medium having stored thereon a program that enables a computer, after the program is loaded into memory of the computer, to process information in monitoring systems for the ethics, risk and/or value management, whereby data received by a computer system are searched and evaluated and/or classified according to predefined patterns,
the data are erased or provided for further processing depending on the evaluation of the data, the further processing of the data comprises the following steps:
evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

30. Method for using a process for information processing in monitoring systems for ethics, risk and/or value management,
characterized in that
a monitoring systems is provided by a supplier for the ethics, risk and/or value management, wherein the monitoring system searches and evaluates and/or classifies data received by a computer system for predefined patterns,
erases the data or provides the data for further processing depending on the evaluation of the data,
wherein further processing of the data comprises the following steps:
evaluating the data,
depending on the results of the evaluation of the data, determining additional associated data by a database query,
depending on the results of the preceding steps, generating a data set that is enlarged by the associated data,
depending on the results of the preceding steps, transmitting at least a portion of the enlarged data set to a person or persons identified by the content of the enlarged data set.

31. Method according to claim 30,
characterized in that
the supplier of the monitoring system for the ethics, risk and/or value management and/or or a corporation awarding an order establishes a Corporate Incident Postbox (37) and/or a Direct Internal Postbox (38) for receiving messages (9) and/or for communication between the monitoring system and the informant (12).

32. Method according to claim 30,
characterized in that
the corporation awarding the contract makes available to one or more persons access data to the Corporate Incident Postbox (37).

33. Method according to claim 30,
characterized in that
an anonymous and/or silent postbox (3) can be established within the Corporate Incident Postbox (37).

34. Method according to claim 30,
characterized in that
a targeted, detailed statistics is generated for harmful and/or forensic actions related to white-collar crimes.
